(19) United States
(12) Patent Application Publication
(10) Pub. No.: US 2009/0267779 A1
(43) Pub. Date: Oct. 29, 2009

(54) Miniature Night Lamp with Weathercast and Alarm Module

(76) Inventor: Jen-Yen YEN, Puyan Township (TW)

Correspondence Address: SINORICA, LLC, 2275 Research Blvd., Suite 500, ROCKVILLE, MD, 20850, US

(21) Appl. No.: 12/110,211

(22) Filed: Apr. 25, 2008

(51) Int. Cl. G01W 1/00; F21V 33/00

(52) U.S. Cl. 340/601; 362/253

(57) ABSTRACT

A miniature night lamp with weathercast and alarm module comprises a miniature night lamp and a control means. In addition to providing night illumination, the control means is able to receive the weathercast signal of the weather bureau and let the user to hear information about the local weather conditions, and should there be any abnormal weather conditions the control means is able to deliver a sound alarm from a speaker.

### BACKGROUND OF THE INVENTION

1. Field of the invention

The present invention relates to miniature night lamp with weathercast and alarm module, and in particular, to a miniature night lamp which in addition to usable as a night lamp, is equipped with a weathercast and alarm module to offer the user a forecast of weather conditions and a sound alarm should there be a possible occurrence of abnormal weather.

2. Description of the Prior Art

The miniature night lamp is essentially installed at the dark corner in the house such as the bed side, corridor, or the staircase for provision of security lighting in the night time therefore it is necessary in the normal domestic life. How it will be more satisfactory if it can be added an extra function to it, for example, an contrivance to listen to radio broadcast about weather conditions and caution of possible change of weather to happen.

Aiming at the above depicted intention, the present invention is to propose a newly developed contrivance of a miniature night lamp with weathercast and alarm module which not only provides night security illumination but also capable of making a forecast of weather conditions and a sound alarm should there be a possible occurrence of abnormal weather.

### SUMMARY OF THE INVENTION

It is an object of the present invention to provide a miniature night lamp with weathercast and alarm module to provide not only night illumination, but also forecast the weather conditions and caution about possible occurrence of abnormal weather.

It is another object of the present invention to provide a miniature night lamp with weathercast and alarm module wherein the user can freely select the weather broadcast station which he/she likes to listen to.

To achieve the above objects, the contrivance of the present invention comprises a main body of the lamp, a power supply and a control means. An alternating current supplied from the power supply is transmitted to the miniature night lamp for illumination after been converted into DC, and the power is also transmitted to the control means as a power for normal work. A multi control unit (MCU) contained in the control means receives signal from a change over switch and a frequency channel selective switch and transfers the deciphered signal to a phase lock loop whereat an oscillation frequency designated by the MCU is equalized in phase with a reference frequency. Afterwards the signal is transmitted to a frequency mixer which in addition to receive the signal from the phase lock loop, it able to receive signals delivered from the weather-bureau through an antenna, and mix the signal received from the antenna with the signal transmitted from the phase lock loop to obtain a first medium frequency signal. The first medium frequency signal is transmitted to a frequency converter whereat it is converted into a second medium frequency signal. The second medium frequency signal is then transmitted to an audio frequency amplifier and the MCU. The audio frequency amplifier amplifies the audio signal and the sound broadcast is outputted by a speaker. The information about abnormal weather conditions contained in the second medium frequency signal, if any, is deciphered by the MCU and an alarm is actuated by the MCU to make a sound alarm from the speaker.

These features and advantages of the present invention will be fully understood and appreciated from the following detailed description of the accompanying Drawings.

### BRIEF DESCRIPTION OF THE DRAWINGS

FIG. 1 is a perspective view of the present invention.

FIG. 2 is a block diagram showing the arrangement of the parts of the present invention.

### DETAILED DESCRIPTION OF THE PREFERRED EMBODIMENT

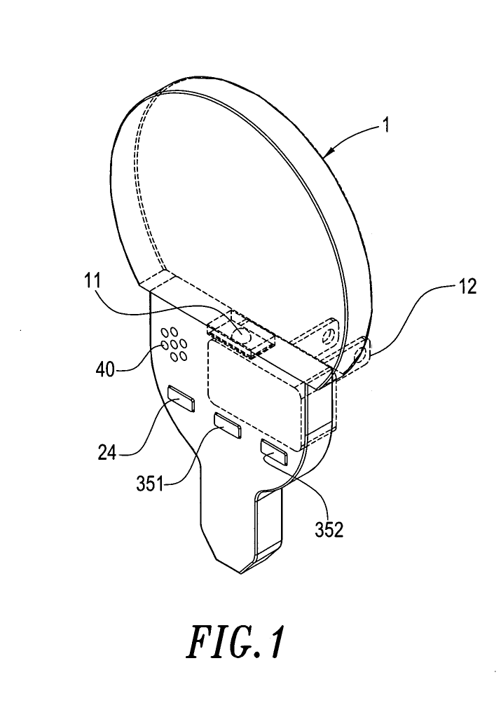

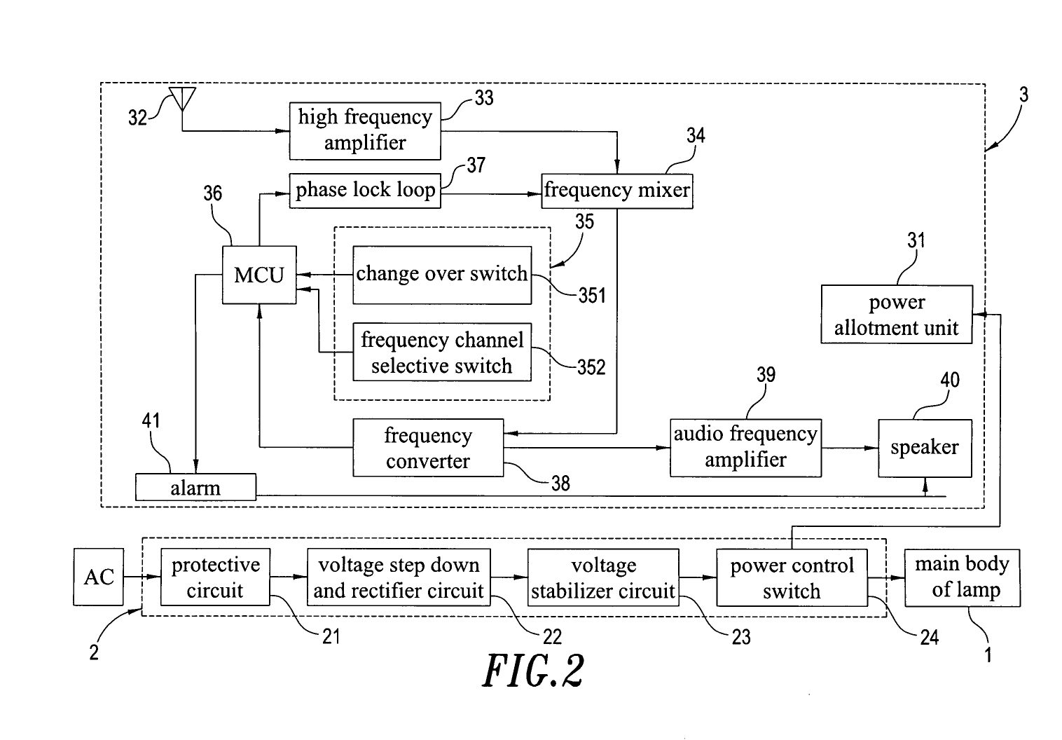

Referring to FIG. 1 and FIG. 2, the miniature night lamp with weathercast and alarm module essentially comprises following component devices:

A main body of the miniature night lamp 1 having a light source 11 and a male attachment plug 12.

A power supply 2 composed of a protective circuit 21, a voltage step down and rectifier circuit 22, a voltage stabilizer circuit 23 and a power control switch 24. The protective circuit 21 is connected with the male attachment plug 12 to input the alternating power current. The alternating voltage herein is stepped down and rectified by the voltage step down and rectifier circuit 22 and stabilized by the voltage stabilizer circuit 23. Afterwards the stabilized DC power is supplied to the main body of lamp 1 to make the light source 11 to turn on and to a control means 3 to work.

The control means 3 comprises the following component parts:

A power allotment unit 31 which receives the stabilized DC from the power supply 2 and dispenses power to all component circuits included in the control means for normal work.

An antenna 32 to receive a frequency signal delivered by the weathercast bureau and transmit this signal to a high frequency amplifier 33.

The high frequency amplifier 33 receives the signal from the antenna 32 and transmits this signal to a frequency mixer 34 after amplifying it.

An input unit 35 comprising a change over switch 351 and a frequency channel selective switch 352, wherein the change over switch 351 is to change over connection between the weather broadcast station and the alarm station, and transmit the received signal to a multi control unit (MCU) 36.

The MCU 36 receives the signals coming from the change over switch 351, the frequency channel selective switch 352 and a frequency converter 38, and analyzes the signal and reports to the MCU 36 about the information as to whether the user is listening to the weather broadcast or the alarm station. If the weathercast is selected, the MCU 36 picks out the signal from exact frequency channel and sends the deciphered signal to a phase lock loop 37.

The phase lock loop 37 receives the signal from the MCU 36 and locks a designated oscillation frequency by MCU 36 with the reference frequency in same frequency and phase, and transmits this locked frequency signal to a frequency mixer 34.

The frequency mixer 34 receives the frequency signals from the high frequency amplifier 33 and the phase lock loop 37, and mixes the two frequency signals to obtain a first medium frequency signal and sends it to a frequency converter 38.

The frequency converter 38 receives the signal from the frequency mixer 34, and converts the first medium frequency signal into a second medium frequency signal to output and perform a better elimination of image interference thereby improving the receiving sensitivity, and outputting the second medium frequency signal to an audio frequency amplifier 39 and the MCU 36.

The audio frequency amplifier 39 amplifies the second medium frequency signal so as to offer it a sufficient power to actuate a speaker 40 thereby enabling the user to hear the weathercast through the speaker 40.

After receiving the second medium frequency signal from the frequency converter 38, the MCU 36 analyzes the second medium frequency signal so as to detect if there be any signal about abnormal weather conditions. If there is, an alarm 41 is actuated to make a sound alarm from the speaker 40 by the audio frequency amplifier 39.

In brief, it emerges from the above description that the invention has several noteworthy advantages, in particular:

1. The present invention not only provides a night illumination, but also makes the user can get information about the weather conditions and timely warning so as to ensure security.

2. It is so convenient that which weather broadcast station to hear is up to the user's free selection.

Many changes and modifications in the above described embodiment of the invention can, of course, be carried out without departing from the scope thereof. Accordingly, to promote the progress in science and the useful arts, the invention is disclosed and is intended to be limited only by the scope of the appended claim.

What is claimed is:

1. A miniature night lamp with weathercast and alarm module comprising a main body of the miniature night lamp, a power supply and a control means, wherein said power supply supplies electrical power to said main body of the lamp and said controls means after converting an alternating power current into a direct power current; said control means further comprising:
a power allotment unit for receiving the stabilized DC from said power supply and dispensing power to all component circuits included in said control means;
an antenna for receiving a frequency signal delivered by the weather bureau and transmitting said signal to a high frequency amplifier to amplify, and transmitting said signal to a frequency mixer after being amplified;
an input unit for receiving a selected channel, and sending the selected result to a multi control unit (MCU);
said MCU for receiving the signals from said input unit and a frequency converter, and transmitting the analyzed signal to a phase lock loop;
said phase lock loop for receiving the signal from said MCU and locking a designated oscillation frequency and the reference frequency in same frequency and phase, and transmitting said locked frequency signal to a frequency mixer;
said frequency mixer for receiving and mixing the frequency signals from a high frequency amplifier and said phase lock loop to obtain a first medium frequency signal, and sending it to a frequency converter;
said frequency converter for converting said first medium frequency signal into a second medium frequency signal to output to an audio frequency amplifier and said MCU.
said audio frequency amplifier for amplifying said second medium frequency signal so as to actuate a speaker to broadcast weather conditions; wherein,
said MCU analyzes said second medium frequency signal so as to detect if there be any signals about abnormal weather conditions, if there is, an alarm is actuated to make a sound alarm from said speaker by said audio frequency amplifier.

2. The miniature night lamp of claim 1, wherein said power supply is composed of a protective circuit, a voltage step down and rectifier circuit, a voltage stabilizer circuit and a power control switch, said protective circuit inputs the Ac power supply and the AC voltage is stepped down and rectified by said voltage step down and rectifier circuit and the resultant DC voltage is stabilized by said voltage stabilizer circuit, afterwards the stabilized DC power is supplied to said main body of the miniature night lamp to turn on and said control means to work.

3. The miniature night lamp of claim 1, wherein said input unit comprises a change over switch to change over connection between the weather broadcast station and the alarm station, and transmit the received signal to said MCU.

4. The miniature night lamp of claim 1, wherein said input unit comprises a frequency channel selective switch for selecting the frequency channel of weathercast for the user to listen to the information about the local weather conditions, and reports the selected result to said MCU with a signal.
